(19) United States
(12) Patent Application Publication
(10) Pub. No.: US 2024/0226851 A1
(43) Pub. Date: Jul. 11, 2024

(54) PROCESS FOR MANUFACTURING LITHIUM SELECTIVE ADSORBENTS

(71) Applicant: ILiAD IP COMPANY, LLC, Carlsbad, CA (US)

(72) Inventor: Charles R. Marston, Midland, MI (US)

(73) Assignee: ILiAD IP COMPANY, LLC, Carlsbad, CA (US)

(21) Appl. No.: 18/409,721

(22) Filed: Jan. 10, 2024

Related U.S. Application Data
(63) Continuation-in-part of application No. 18/153,329, filed on Jan. 11, 2023, now Pat. No. 11,904,297.
(60) Provisional application No. 63/479,539, filed on Jan. 11, 2023.

(51) Int. Cl. B01J 20/32; B01J 20/04; B01J 20/08; B01J 20/30

(52) U.S. Cl. CPC B01J 20/3234; B01J 20/041; B01J 20/08; B01J 20/3078; B01J 20/3085; B01J 2220/42

(57) ABSTRACT

This invention generally relates to a process for manufacturing a lithium selective adsorbent and, more particularly, to a process for manufacturing a lithium selective adsorbent using a recycled and augmented intercalation reaction liquor. An initial quantity of adsorbent precursor is intercalated with lithium using an intercalation reaction liquor to produce an intercalated layered aluminate adsorbent and a post-intercalation reaction liquor. The post-intercalation reaction liquor is decanted, and the intercalated layered aluminate adsorbent is neutralized to produce the lithium selective adsorbent. The decanted intercalation reaction liquor is reconstituted to a pre-intercalation reaction volume of the intercalation reaction liquor, which is recycled to intercalate a subsequent quantity of adsorbent precursor.

### CROSS-REFERENCE TO RELATED APPLICATIONS

This application is a continuation-in-part of U.S. patent application Ser. No. 18/153,329, filed on Jan. 11, 2023, and claims the benefit of U.S. Provisional Patent Application No. 63/479,539, filed on Jan. 11, 2023; and this application incorporates said non-provisional application and provisional application by reference into this document as if fully set out at this point.

### BACKGROUND OF THE INVENTION

### 1. Field of the Invention

The subject matter disclosed herein relates to a process for manufacturing lithium selective adsorbents and, more particularly, to a process for manufacturing a lithium selective adsorbent using a recycled and augmented intercalation reaction liquor.

### 2. Description of the Related Art

The growing demand for lithium in various applications, particularly lithium-ion batteries, means that lithium-bearing brines are becoming increasingly attractive as new energy resources. Consequently, there is a growing demand for effective lithium selective adsorption media for direct lithium extraction (DLE), particularly aluminum-based adsorbent products.

Lithium salts are required in significant quantities for the production of aluminum hydroxide-based lithium selective adsorbents. In traditional manufacturing processes, excess lithium salts are employed to drive intercalation processes to produce lithium selective adsorbents for lithium recovery. Conventional adsorbent formulations rely on super-stoichiometry (i.e., excess lithium) to drive the conversion of Al(OH)₃ to the lithium selective adsorption media.

The use of excess lithium salts in these traditional methods results in lithium losses. The market price of lithium salts, therefore, strongly influences the overall cost of manufacturing lithium-selective adsorbents. At the commercial scale, without reducing the amount of lithium salt used in the manufacturing process, the cost could be non-economical, and waste management could be costly. Moreover, there is a need in the industry to make adsorbent manufacturing zero waste discharge facilities.

### SUMMARY OF THE INVENTION

The invention relates to a process for manufacturing lithium selective adsorbent containing LADH. With the increasing value of lithium in the marketplace and the drive toward zero discharge at production facilities, the inventive process improves the economic and environmental impact of manufacturing lithium selective adsorbent by recycling the lithium-containing reaction intercalation liquor. At the commercial scale, without recycling and reusing the lithium chloride in subsequent intercalation, the lost lithium chloride could be non-economical, and waste management could be costly.

Accordingly, it is an object of this invention to provide a process that efficiently manufactures a LADH lithium selective adsorbent that converts crystalline aluminum trihydroxides (Al(OH)₃) to LADH using a recycled and augmented intercalation reaction liquor. The recycled and augmented intercalation reaction liquor is produced during intercalation of the adsorbent precursor using a lithium salt in a dilute brine and is augmented with a makeup volume to reconstitute the intercalation reaction liquor.

In general, in a first aspect, the invention relates to a process for manufacturing a lithium selective adsorbent. The process intercalates an initial quantity of an adsorbent precursor with lithium under alkaline conditions at a predetermined intercalation temperature using a pre-intercalation reaction volume of an intercalation reaction liquor to produce an intercalated layered aluminate adsorbent and a post-intercalation reaction volume of a partially depleted intercalation reaction liquor. The post-intercalation reaction volume of the partially depleted intercalation reaction liquor is decanted from the intercalated layered aluminate adsorbent to obtain a decanted intercalation reaction liquor. The intercalated layered aluminate adsorbent is then neutralized under acidic conditions at a predetermined neutralization temperature to produce the lithium selective adsorbent. The decanted intercalation reaction liquor is augmented by adding a makeup volume to reconstitute the pre-intercalation reaction volume and obtain an augmented intercalation reaction liquor, which is recycled for intercalating a subsequent quantity of the adsorbent precursor.

In an embodiment, the intercalation temperature can be between about 25° C. and about 125° C. (and any range or value therebetween), and more particularly, between about 85° C. and about 105° C. or greater than 100° C. to about 105° C.

In an embodiment, the alkaline conditions can have a pH from about 7 to about 13 (and any range or value therebetween), and more particularly, between about 9 and about 12.

In an embodiment, the intercalation reaction liquor can include a lithium salt and

an alkali in a dilute brine.

In an embodiment, the lithium salt can be LiCl, LiNO₃, LiBr, LiOH, or a mixture thereof, and more particularly, the lithium salt can be LiCl or LiOH.

In an embodiment, the lithium salt in the intercalation reaction liquor can have a concentration ratio of about 1:1 to about 5:1 Li to Al.

In an embodiment, the alkali can be an alkali hydroxide, an alkaline earth metal hydroxide, a strong base, a monoacid base, ammonia, or a mixture thereof. The alkali can be KOH, NaOH, LiOH, or a mixture thereof, and more particularly, the alkali can be NaOH or LiOH. The alkali can have a concentration between about 1 and about 3 mol of the alkali per mol of Al(OH)₃ in the adsorbent (and any range or value therebetween), and more particularly, greater than 1 to about 3 mol of the alkali per mol of Al(OH)₃ in the intercalated layered aluminate adsorbent, or more particularly, about 1 to 1.5 mol of the alkali per mol of Al(OH)₃ in the adsorbent, and more particularly, greater than 1 to about 1.5 mol of the alkali per mol of Al(OH)₃ in the intercalated layered aluminate adsorbent.

In an embodiment, the lithium salt is LiOH, and the alkali is LiOH.

In an embodiment, the brine contains a majority of chloride salts, and can be NaCl, NaBr, NaNO₃, KCl, KBr, or a mixture thereof.

In an embodiment, the brine is NaCl, the lithium salt is LiCl, and the alkali is NaOH.

In an embodiment, the brine is KCl, the lithium salt is LiOH, and the alkali is LiOH.

In an embodiment, the step of intercalating the initial quantity of the adsorbent precursor can also include intercalating the initial quantity of the adsorbent precursor by heating to the predetermined intercalation temperature for a predetermined amount of intercalation time. The predetermined amount of intercalation time can be between about 0.375 hours and about 390 hours (and any range or value therebetween), and more particularly, greater than 100 hours to about 390 hours, and more particularly, between about 1.5 hours and about 6 hours.

In an embodiment, the neutralization temperature can be between about 25° C. and about 115° C. (and any range or value therebetween), and more particularly, between about 65° C. and about 80° C., and more particularly, greater than 70° C. to about 80° C.

In an embodiment, the step of intercalating the initial quantity of the adsorbent precursor can also include intercalating the initial quantity of the adsorbent precursor under acidic conditions. The acidic conditions can have a pH from about 4.5 to about 7 (and any range or value therebetween), and more particularly, between about 5 and about 5.8, and more particularly, greater than 5 to about 5.8.

In an embodiment, the acid is a strong acid, a mineral acid, a sulfonic acid, a carboxylic acid, or a mixture thereof. The acid can be hydrochloric acid, sulfuric acid, nitric acid, phosphoric acid, hydrobromic acid, perchloric acid, formic acid, acetic acid, or a mixture thereof, and more particularly, the acid can be acetic acid. The acid can have a concentration of between about 5% and about 100% (and any range or value therebetween).

In an embodiment, the step of neutralizing the intercalated layered aluminate adsorbent can include neutralizing the intercalated layered aluminate adsorbent for a predetermined amount of neutralization time.

In an embodiment, the predetermined amount of neutralization time can be between about 0.03125 hours and about 16 hours (and any range or value therebetween), and more particularly, between about 0.25 hours and about 1 hours, or more particularly less than 2 hours.

In an embodiment, the makeup volume can include a makeup brine, a makeup lithium salt, a makeup alkali, or a mixture thereof.

In an embodiment, the makeup brine can be NaCl, NaBr, NaNO₃, KCl, KBr, or a mixture thereof.

In an embodiment, the makeup lithium salt can be LiCl, LiNO₃, LiBr, LiOH, or a mixture thereof.

In an embodiment, the makeup alkali can be KOH, NaOH, LiOH, or a mixture thereof.

In an embodiment, the makeup lithium salt is LiOH, and the makeup alkali is LiOH.

In an embodiment, the makeup brine is NaCl, the makeup lithium salt is LiCl, and the makeup alkali is NaOH.

In an embodiment, the makeup brine is KCl, the makeup lithium salt is LiOH, and the makeup alkali is LiOH.

In an embodiment, the step of recycling the augmented intercalation liquor can include filtering the augmented intercalation reaction liquor.

In an embodiment, the steps of intercalating, decanting, neutralizing, augmenting, and recycling are successfully repeated until the intercalation reaction liquor is fully depleted or contains excess residual alumina such that the reaction no longer produces high-quality LADH adsorbents. The steps of intercalating, decanting, neutralizing, augmenting, and recycling can be successfully repeated up to about seven times, more particularly, up to about five times, and more particularly, up to about three times.

In an embodiment, the process can include producing the adsorbent precursor by forming aluminum hydroxide (Al(OH)₃) crystals in situ within pores of an ion exchange resin. The pores of the ion exchange resin can be impregnated with an aluminum chloride (AlCl₃) solution, and then the AlCl₃ impregnated resin is infiltrated with alkali to form Al(OH)₃ microcrystalline seeds within the pores of the ion exchange resin. The Al(OH)₃ seeded resin is infiltrated with an alkaline aluminate solution, and an acid is used to remove excess NaOH produced as the Al(OH)₃ microcrystals grow within the pores.

In an embodiment, the ion exchange resin can be a polystyrene-based ion exchange resin, and more particularly, an organic, porous polystyrene-based ion exchange resin bead. In an embodiment, the ion exchange resin is functionalized as a strong base anion (SBA) or a weakly basic anion (WBA) exchange resin, and the WBA exchange resin can be in an HCl form before the step of impregnating the pores of the ion exchange resin with the AlCl₃ solution.

In general, in a second aspect, the invention relates to a lithium selective adsorbent manufactured by the process in the first aspect.

In general, in a third aspect, the invention relates to a lithium aluminum double hydroxide (LADH) lithium selective adsorbent produced by the process in the first aspect.

### BRIEF DESCRIPTION OF THE DRAWINGS

The above and other objects and advantages of this invention may be more clearly seen when viewed in conjunction with the accompanying drawing wherein:

FIG. 1 is a process flow diagram for an exemplary process for manufacturing a lithium selective adsorbent by recycling and augmenting an intercalation reaction liquor in accordance with an illustrative embodiment of the invention disclosed herein.

FIG. 2 is a process flow diagram for an exemplary process of manufacturing a lithium selective adsorbent by recycling and augmenting an intercalation reaction liquor in accordance with an illustrative embodiment of the invention disclosed herein.

FIG. 3 is a process flow diagram for an exemplary process of manufacturing a LADH lithium selective adsorbent by recycling and augmenting an intercalation reaction liquor in accordance with another illustrative embodiment of the invention disclosed herein.

FIG. 4 graphically illustrates LADH adsorbent manufacturing with successive lithium chloride recycles according to an illustrative embodiment of the invention disclosed herein.

FIG. 5 graphically illustrates the lithium chloride savings provided by an illustrative embodiment of the invention disclosed herein.

### DETAILED DESCRIPTION OF THE INVENTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

Generally, lithium aluminum double hydroxide (LADH) lithium selective adsorbents are manufactured from microcrystalline, hydrated aluminum trihydroxides (Al(OH)₃) (e.g., Gibbsite, and its common polymorphs, Boehmite, Bayerite, and Nordstrandite), by heating the hydrated alumina precursor with one or more lithium salts at an elevated pH using alkali chemicals, such as hydroxide salts of sodium, lithium, or potassium. As used herein, Gibbsite includes its common polymorphs, including Boehmite, Bayerite, and Nordstrandite.

The lithium selective adsorbent has an inorganic composition. The term “inorganic,” as used herein, refers to those compositions not containing carbon or wherein carbon is present but in its elemental state. Typically, the inorganic composition includes at least one metal, wherein the term “metal,” as used herein, includes traditionally defined metals as well as metalloids (those elements having both metallic and non-metallic properties and which overlap with the main group elements). The inorganic composition can be or can include a metal oxide composition, such as silica, Gibbsite, alumina, (e.g., alumina, θ-Al₂O₃, χ-Al₂O₃, κ-Al₂O₃, ε-Al₂O₃, δ-Al₂O₃, AlO(OH), pseudoboehmite, or a combination thereof) or an aluminosilicate, such as a zeolite, e.g., MFI-type, MEL-type, MTW-type, MCM-type, BEA-type, faujasite, or ZSM-type zeolites. The metal oxide composition may alternatively be or include, for example, zirconium oxide, yttrium oxide, titanium oxide, cerium oxide, chromium oxide, copper oxide, nickel oxide, or hafnium oxide, or a combination thereof.

The inorganic composition can include a metal carbide composition, such as silicon carbide, iron carbide (e.g., steel), tungsten carbide, titanium carbide, molybdenum carbide, or boron carbide, or combination thereof.

The inorganic composition can include a metal nitride composition, such as boron nitride, silicon nitride, silicon oxynitride, silicon carbide nitride, aluminum nitride, tantalum nitride, or zirconium nitride, or combination thereof. Alternatively, the inorganic composition can include a metal boride composition, such as aluminum boride, titanium boride, cobalt boride, tantalum boride, or magnesium boride, or combination thereof. The inorganic composition can also include a ceramic composition, which may be an oxide, carbide, nitride, or boride material.

The support for the lithium selective adsorbent can be a polymer, for example, a polyimide, polyether ether ketone (PEEK), polybenzimidazole, ionomer (e.g., sulfonated tetrafluoroethylene, such as Nafion®), polysiloxane (e.g., a silicone rubber or foam), polyurethane, polycarbonate, polyethyleneimine (PEI), polyester (e.g., polyethylene terephthalate), polyamide (e.g., a nylon), vinyl addition polymer (e.g., polyvinylchloride, polyethylene, polypropylene, polystyrene or a fluoropolymer, such as PVDF or PTFE), a mixture of polymers or a copolymer that includes one or more of any of the foregoing polymers. The polymer may alternatively be a composite that includes at least one of the foregoing polymers, wherein the composite includes separate regions (e.g., layers) of polymers of different compositions. The polymer may alternatively be an ion exchange resin bead or particle.

As used herein, the lithium selective adsorbent can have any of the lithium aluminum intercalate LADH forms known in the art, such as lithium aluminum layered double hydroxide chloride (LiCl·2Al(OH)₃), Gibbsite-based lithium aluminum layered double hydroxide, lithium aluminum intercalate (LiAl₂(OH)₆Cl) (“LADH”) crystals in microporous, polymeric resin beads or other suitable adsorbent support noted above.

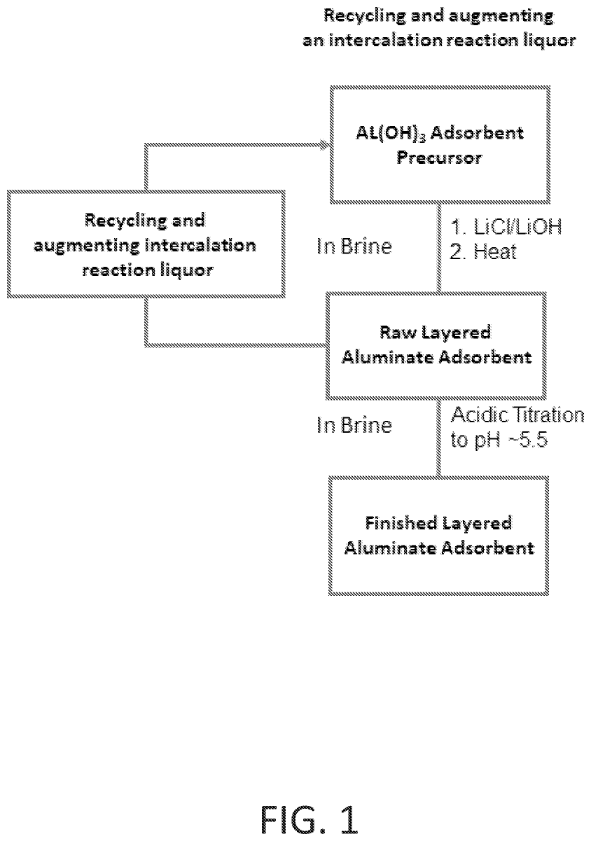

The invention disclosed herein is directed to a process for manufacturing a lithium selective adsorbent containing LADH using a recycled and augmented intercalation reaction liquor. FIG. 1 illustrates an exemplary process flow diagram for the inventive manufacturing process. As exemplified, the inventive process for manufacturing a LADH lithium selective adsorbent grows lithium aluminum intercalate (LiAl₂(OH)₆Cl) crystals (e.g., provides an alumina-based or Gibbsite-bearing adsorbent precursor) in situ within open cavities of an organic, porous ion exchange resin or beads. The ion exchange resin is seeded with hydrous crystalline alumina by initially impregnating the pores of the organic ion exchange resin or beads with an aluminum chloride (AlCl₃) solution. Aluminum chloride forms a Lewis Acid/Lewis Base complex with electron rich functionality within the pores. Suitable ion exchange resins include a dimethylamine functionalized chloromethylated copolymer of styrene and divinylbenzene and a polystyrene-based ion exchange resin, and more particularly, an organic, porous polystyrene-based ion exchange resin bead. The ion exchange resin may be functionalized as a strong base anion (SBA) or a weakly basic anion (WBA) exchange resin, and the WBA exchange resin can be in an HCl form before the step of impregnating the pores of the ion exchange resin with the AlCl₃ solution.

The AlCl₃-impregnated resin beads are then infiltrated with alkali (e.g., ammonia, sodium hydroxide or lithium hydroxide), thereby forming aluminum hydroxide (Al(OH)₃) (e.g., Gibbsite) microcrystals (seeds) on the surface of internal pores of the ion exchange resin beads. Equation 1 demonstrates an exemplary embodiment of this reaction.

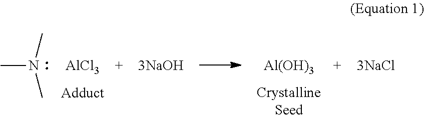

Aluminum hydroxide microcrystal seed formation is followed by infiltration with an alkaline aluminate solution (e.g., sodium aluminate), and an acid is used to remove excess NaOH produced in the crystalline reformation of Al(OH)₃ in-situ generally as Gibbsite within the pores of the resin beads. The seeds of hydrous crystalline alumna within the pores are used as growth sites for producing additional crystallized Al(OH)₃ with alkaline aluminate solution treatments. Equation 2 demonstrates an exemplary embodiment of this reaction.

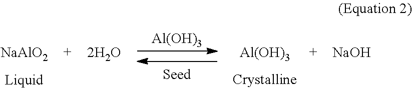

The inventive process then intercalates the crystalline hydrous alumina in the pores to LADH by treating the Al(OH)₃ loaded resin beads with lithium salt in a dilute brine with alkaline conditions at a predetermined elevated intercalation temperature. The inventive intercalation process is generally performed with a stoichiometric excess of lithium salt in a stoichiometrically dilute brine to drive the reaction forming LADH from Gibbsite. An exemplary embodiment of this reaction is outlined by Equation 3.

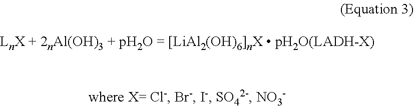

Once intercalated with lithium, the LADH adsorbent is neutralized with an appropriate acid.

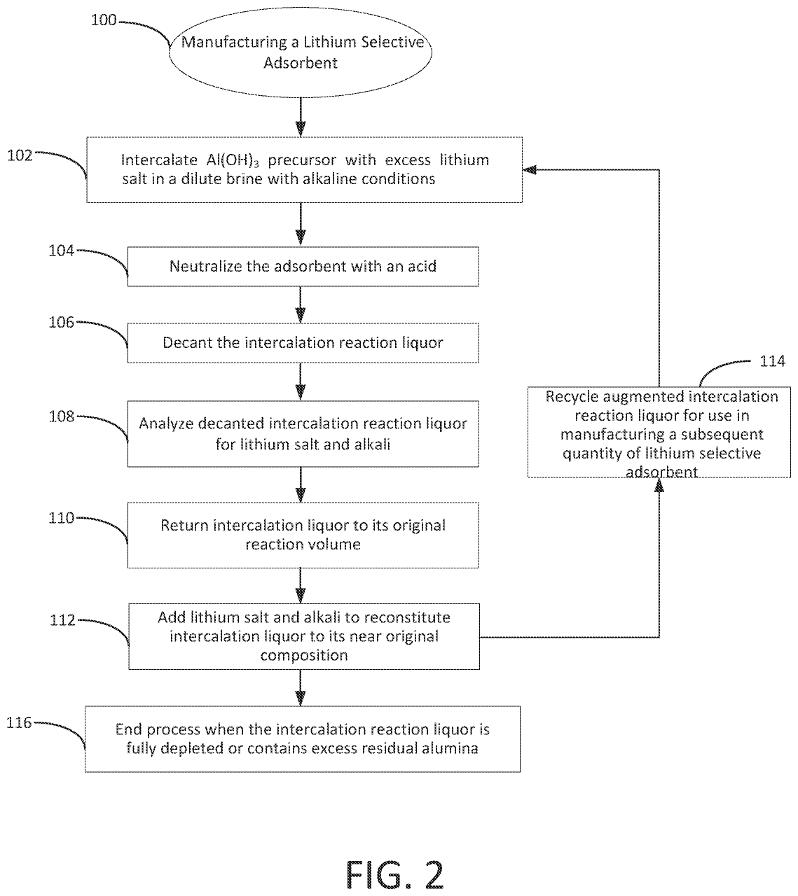

FIG. 2 illustrates an exemplary process flow diagram for the inventive recycling process 100 for manufacturing a lithium selective adsorbent. Upon completion of the aluminum trihydroxide (e.g., Gibbsite) to LADH conversion in step 102 (i.e., reacting Al(OH)₃ loaded resin support with lithium salt in a dilute brine with alkaline conditions) and step 104 (i.e., neutralizing the intercalated layered aluminate adsorbent with an acid to obtain the lithium selective adsorbent), the partially depleted intercalation reaction liquor containing lithium salts can be decanted (step 106) and recycled for use in the manufacturing of LADH adsorbent. Before recycling the intercalation reaction liquor, it is analyzed for lithium and alkali (step 108), returned to its original reaction volume (step 110), and then lithium salt and alkali are added to reconstitute the intercalation reaction liquor to its near original composition (step 112). The process can be applied to Al(OH)₃ precursor either alone or formulated into inorganic or organic matrices. Filtration may be applied to remove any suspended solids that may have formed. The reconstituted, augmented intercalation reaction liquor is employed in the manufacturing process (recycled at step 114 to step 102), and the same procedure is followed, repeating the reconstitution of the intercalation reaction liquor, the addition of lithium salt and alkali, and filtration, if needed. In one embodiment, steps 102 through 114 for this process 100 are successively repeated up to about seven (7) times or until the intercalation reaction liquor is fully depleted or contains excess residual alumina such that the reaction no longer produces high-quality LADH adsorbents (terminating at step 116) to realize significant savings in lithium losses and waste treatment costs. In other non-limiting embodiments, steps 102 through 114 are successively repeated up to about five (5) times or up to about three (3) times.

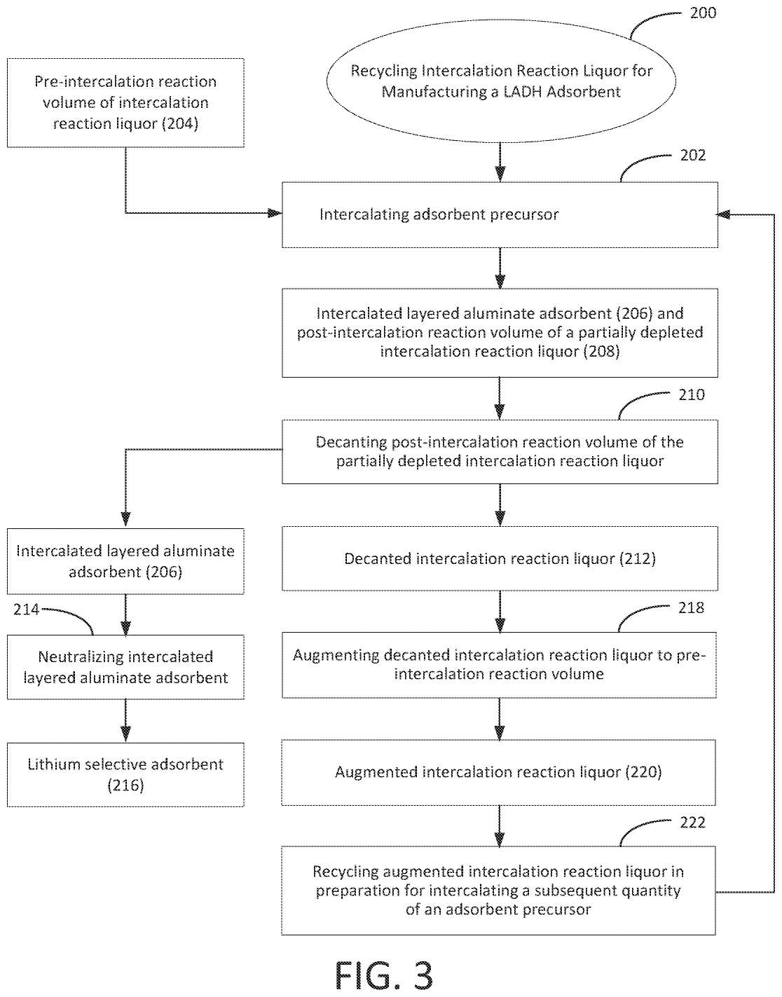

FIG. 3 illustrates another exemplary process flow diagram for the inventive recycling process 200 for manufacturing a lithium selective adsorbent. An initial quantity of alumina-based or Gibbsite-bearing adsorbent precursor is intercalated (step 202) with lithium under alkaline conditions at a predetermined intercalation temperature using a pre-intercalation reaction volume of an intercalation reaction liquor 204. The intercalation reaction liquor 204 includes a lithium salt and an alkali in a brine. In one embodiment, the alumina-based adsorbent precursor is intercalated by heating to the predetermined intercalation temperature in the presence of the lithium salt in the brine under the alkaline conditions for a predetermined amount of intercalation time. The resulting products of this intercalating step include an intercalated layered aluminate adsorbent 206 and a post-intercalation reaction volume of a partially depleted intercalation reaction liquor 208.

The dilute brine used for intercalation in step 202 can be NaCl, NaBr, NaNO₃, KCl, KBr, or a mixture thereof, and other dilute brines preferably containing a majority of chloride salts. Also, the lithium salt can be LiCl, LiNO₃, LiBr, LiOH, or a mixture thereof. The lithium salt in the intercalation reaction liquor 204 is in a ratio with aluminum ranging from about 1:1 to about 5:1 Li to Al (and any range or value therebetween). The alkali in the intercalation reaction liquor 204 yields an alkaline pH from about 7 to about 13 (and any range or value therebetween), and more particularly, a pH between about 9 and about 12. Suitable alkalis include alkali hydroxides, alkaline earth metal hydroxides, strong bases, monoacid bases, ammonia, and mixtures of the same. Without limitation, the alkali can be hydroxides of potassium, sodium, lithium, or of other alkali or alkaline earth metals, other suitable strong or monoacid bases, ammonia (potentially from urea thermal decomposition), or a mixture thereof. The alkali concentration is about 1 to about 3 mol of the alkali per mol of Al(OH)₃ in the lithium selective adsorbent 216 (and any range or value therebetween), and more particularly, greater than 1 to about 3 mol of the alkali per mol of Al(OH)₃ in the intercalated layered aluminate adsorbent 206, or more particularly, the alkali concentration is about 1 to about 1.5 mol of the alkali per mol of Al(OH)₃ in the intercalated layered aluminate adsorbent 206, being processed, more particularly, greater than 1 to about 1.5 mol of the alkali per mol of Al(OH)₃ in the intercalated layered aluminate adsorbent 206. In one non-limiting embodiment, the dilute brine includes NaCl, the lithium salt includes LiOH, and the alkali includes NaOH. In another non-limiting embodiment, the dilute brine includes KCl, NaCl, or both, while the lithium salt and the alkali are both LiOH.

The predetermined elevated intercalation temperature for step 202 can be between about 25° C. and about 125° C. (and any range or value therebetween, including without limitation the values shown in Table 1 and the ranges therebetween), and more particularly, between about 85° C. and about 105° C. In one non-limiting embodiment, the intercalation temperature is greater than 100° C. to about 105° C. As shown in Table 1, depending upon the intercalation temperature, the intercalation time can be between about 0.375 hours and about 390 hours (and any range or value therebetween, including without limitation the values shown in Table 1 and the ranges therebetween), more particularly, between about 0.75 hours and about 390 hours, and more particularly, about 1.5 hours to about 6 hours. In one embodiment, the intercalation time is greater than 100 hours to about 390 hours.

TABLE 1
Intercalation Time and Temperatures.

| | Temperature (° C.) | | | | | | | | | | |
|---|---|---|---|---|---|---|---|---|---|---|---|
| | 125 | 115 | 105 | 95 | 85 | 75 | 65 | 55 | 45 | 35 | 25 |
| Time | 0.375 | 0.75 | 1.5 | 3 | 6 | 12 | 24 | 48 | 96 | 192 | 390 |
| (Hours) | | | | | | | | | | | |

The post-intercalation reaction volume of the partially depleted intercalation reaction liquor 208 is decanted from the intercalated layered aluminate adsorbent 206 (step 210) to obtain a decanted intercalation reaction liquor 212.

The intercalated layered aluminate adsorbent 206 is neutralized (step 214) under acidic conditions to an acidic pH of about 4.5 and about 7 (and any range or value therebetween), and more particularly, a pH between about 5 and about 5.8. The intercalated layered aluminate adsorbent 206 is neutralized using an acid at a predetermined neutralization temperature to produce the lithium selective adsorbent 216. The acid can be hydrochloric, sulfuric, nitric, phosphoric, hydrobromic, perchloric, formic, acetic, or other suitable strong, mineral, sulfonic, or carboxylic acids, or a mixture thereof. The acid can have a concentration of between about 5% and about 100% (and any range or value therebetween).

As shown by Table 2, the neutralization temperature for step 214 can range from about 25° C. to about 115° C. (and any range or value therebetween, including without limitation the values shown in Table 2 and the ranges therebetween), and more particularly, from between about 65° C. and about 80° C. In one embodiment, the neutralization temperature is greater than 70° ° C. to about 80° C. Step 214 of neutralizing the intercalated layered aluminate adsorbent is performed for a predetermined amount of neutralization time, which can range between about 0.03125 hours and about 16 hours (and any range or value therebetween, including without limitation the values shown in Table 2 and the ranges therebetween), and more particularly, from between about 0.25 hours and about 1 hour. In one embodiment, the neutralization time is less than 2 hours.

TABLE 2
Neutralization Time and Temperatures.

| | Temperature (° C.) | | | | | | | | | |
|---|---|---|---|---|---|---|---|---|---|---|
| | 115 | 105 | 95 | 85 | 75 | 65 | 55 | 45 | 35 | 25 |
| Time | 0.03125 | 0.0625 | 0.125 | 0.25 | 0.5 | 1 | 2 | 4 | 8 | 16 |
| (Hours) | | | | | | | | | | |

Turning to step 218, the decanted intercalation reaction liquor is augmented by adding a makeup volume to reconstitute the pre-intercalation reaction volume of the intercalation reaction liquor and to obtain an augmented intercalation reaction liquor 220. It will be appreciated that step 218 may occur before, after, or simultaneously with step 214. The makeup volume includes makeup brine, a makeup brine, an makeup lithium salt, an makeup alkali, or a mixture thereof. The makeup volume can contain a stoichiometric excess of lithium salt in a stoichiometrically dilute brine. Suitable brines, lithium salts, and alkali for augmenting the decanted intercalation reaction liquor in step 218 include those that are suitable for the intercalating step (step 202). The makeup brine, the makeup lithium salt, and/or the makeup alkali in step 218 may have the same or different components as the brine, the lithium salt, and the alkali used in step 202. Without limitation, the makeup brine may be NaCl, NaBr, NaNO₃, KCl, KBr, or a mixture thereof, and other dilute brines preferably containing a majority of chloride salts; the makeup lithium salt may be LiCl, LiNO₃, LiBr, LiOH, or a mixture thereof; and the makeup alkali may be KOH, NaOH, LiOH, or a mixture thereof. In one non-limiting embodiment, the makeup brine is NaCl, the makeup lithium salt is LiCl, and the makeup alkali is NaOH. In another non-limiting embodiment, the makeup lithium salt and the makeup alkali are both LiOH, where the makeup brine is optionally KCl.

The augmented intercalation reaction liquor 220 is recycled (step 222) in preparation for intercalating a subsequent quantity of alumina-based adsorbent precursor (i.e., step 202 is repeated using the augmented intercalation reaction liquor 220 in place of the intercalation reaction liquor 204). This recycling may involve filtering the augmented intercalation reaction liquor 220, if necessary, prior to intercalating the subsequent quantity of alumina-based adsorbent precursor. In one embodiment, steps 202, 210, 214, 218, and 222 are successively repeated until the intercalation reaction liquor is fully depleted or contains excess residual alumina such that the reaction no longer produces high-quality LADH adsorbents. In other non-limiting embodiments, steps 202, 210, 214, 218, and 222 are successively repeated up to about seven (7) times, up to about five (5) times, or up to about three (3) times.

### EXAMPLES

The process for manufacturing lithium selective adsorbent is further illustrated by the following examples, which are provided for the purpose of demonstration rather than limitation.

### Example 1—Augmenting and Recycling Intercalation Reaction Liquor

A sample of LADH lithium selective adsorbent was damaged by the complete de-intercalation, which reverted the LADH of the adsorbent back to Gibbsite. Twenty-five milliliters (25 mL) of the LADH adsorbent was slurried in 50 mL of 15% sodium chloride brine. Ten grams (10 g) of 50% NaOH and 10 g of LiCl were added to the slurry, and the slurry was gently stirred and placed in a 95° C. oven overnight. The partially depleted intercalation reaction liquor containing excess lithium salts was decanted away from the intercalated layered aluminate adsorbent, and the pH of the decanted intercalation reaction liquor was measured to be 9.1. The decanted intercalation reaction liquor is saved for use in a subsequent conversion of Gibbsite-bearing adsorbent to the active LADH form.

The decanted intercalated layered aluminate adsorbent was slurried into 50 mL of fresh de-intercalation solution (i.e., water with less than about 100 ppm Li as LiCl), heated to 75° C., and the pH of the slurry was 9.1. At 75° C., the adsorbent slurry was titrated slowly using a few milliliters of acetic acid (glacial or dilute) until the pH held between 5 and 6 for 30 min. The augmented and titrated sample was rinsed with one volume of de-intercalation solution.

### Example 2—Manufacturing of LADH Adsorbent Using the Augmented and Recycled Intercalation Reaction Liquor

A nearly 20-fold stoichiometric excess of lithium chloride is employed in converting the Gibbsite within the adsorbent precursor to its lithium-selective LADH form (the intercalation step). This example outlines a process for recycling lithium chloride in a subsequent intercalation of latent Gibbsite to LADH.

A fresh 25 mL sample of Gibbsite-bearing adsorbent precursor was activated to the LADH form using the recovered reaction liquor of Example 1. The 42.4 mL of saved decanted intercalation reaction liquor from recycle 0 (Example 1) was augmented with 8.6 mL fresh 15% NaCl brine, returning it to its original 50 mL volume. The augmented intercalation reaction liquor was filtered to remove suspended solids, such as aluminum hydroxide and sodium salts, and then analyzed for lithium and free hydroxide. The lithium concentration was 26.5 g/L which is ˜81% of the original lithium concentration. The lithium concentration was returned to about 32.75 g/L by the addition of 1.9 g LiCl. In addition, 2 g of fresh 50% sodium hydroxide was added to reconstitute the alkali.

The 25 mL sample of Gibbsite-bearing precursor was treated in the same fashion as in Example 1 but using the recycled and augmented intercalation reaction liquor. As in Example 1, the slurry was gently mixed and placed in an oven at 95° C. for 6 hr. Then the slurry was again gently mixed, and the pH was taken and was measured at 9.8. As a general process, if the pH was less than 9.0, 1 g of 50% NaOH would be added to sufficiently increase the pH. Heating was continued for an additional 6 hr.

After cooling to 75° C., the depleted intercalation reaction liquor was decanted and saved for use in a subsequent recycle. The intercalated layered aluminate adsorbent sample created (recycle 1) was neutralized hot with titration by acetic acid, as in Example 1. The neutralized sample (lithium selective adsorbent) was placed in the cycle testing apparatus and run for 25 intercalation/elute cycles. The results after 25 cycles for recycle 1 were recorded, and the reversible lithium loading capacity for recycle 0 (Example 1) was taken as 100% for comparison to subsequent recycles using identical samples of Gibbsite-bearing precursor.

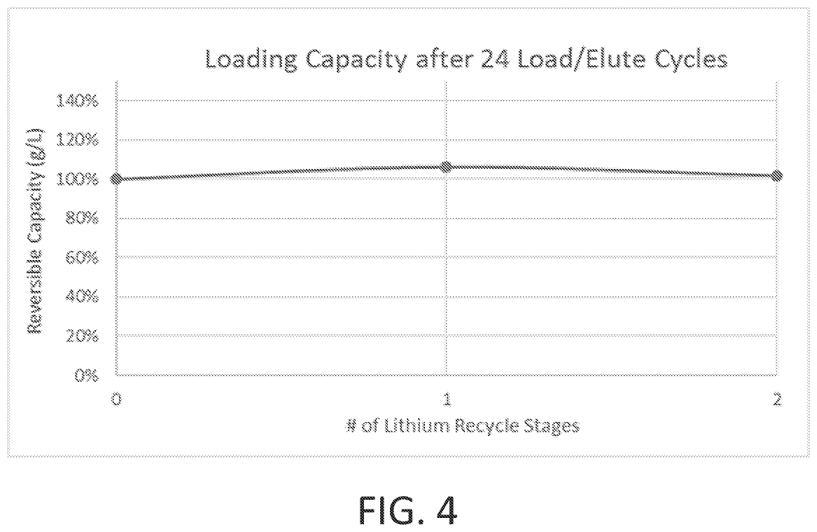

The same process was used in recycling the intercalation reaction liquor for 2 recycles of the liquor (recycle 1 and 2). The graph of FIG. 4 shows that these successive recycles successfully produced LADH adsorbents each time.

Example 2 demonstrates that with the large stoichiometric excess of LiCl employed in the intercalation step, the high initial LiCl usage can be mitigated by successive recycling of the intercalation reaction liquor.

### Example 3—Manufacturing a LADH Adsorbent Using a Recycled and LiOH Augmented Intercalation Reaction Liquor in a KCl Brine

In Example 3, a sample of Gibbsite-bearing adsorbent precursor was divided into 100 mL portions and successively intercalated by recycling the intercalation reaction liquor. Specifically, Example 3 includes a first intercalation using an initial intercalation reaction liquor (Prep Cycle 1) and three subsequent cycles (Prep Cycles 2 through 4) using an augmented intercalation reaction liquor. Between each 100 mL intercalation, the reaction liquor's lithium and alkali content was augmented using LiOH·H₂O. The reaction media was 17% KCl brine solution. These changes ensure that there is no unwanted build-up of NaCl in the intercalation reaction liquor and that the lithium reagents are from a more commercially available source.

For the first intercalation, in a PVDF-coated beaker, 100 mL of Gibbsite adsorbent precursor was slurried in 100 mL 17% KCl brine. Nine grams (9 g) of LiCl and 10.6 g of LiOH·H₂O were added to the slurry, and the slurry was gently stirred until fully mixed. The beaker was loosely covered and placed in a 95° C. oven. After 6 hr, water was added to return the slurry to its original volume, and the beaker was then returned to the 95° C. oven for an additional 6 hr. After a total of 12 hr, the beaker was removed from the oven, and the slurry was returned to its initial volume with water. The slurry was gently mixed and then poured into a 1-inch diameter Pyrex ion exchange column with a sintered PVDF straining disk. The intercalation reaction liquor was drained into a separate beaker for use in the next cycle. The flow was stopped when the reaction liquor was level with the top of the resin bed. To the column was added 50 mL (˜½ bed volume) of water, and the water was slowly drained through the bed and out to the beaker. This process displaced the bulk of the intercalation reaction liquor to the beaker, and very little remained in the adsorbent sample. The adsorbent sample was then titrated to a lasting pH between about 5 and about 5.5 at about 70° C. to about 75° C. using acetic acid and saved for cycle testing. The sample was labeled “Prep Cycle 1.”

In a clean PVDF beaker, a second portion of 100 mL of Gibbsite-bearing adsorbent precursor was slurried with the recycled intercalation reaction liquor from Prep Cycle 1 to which 0.6 g of LiOH H₂O was added, and the slurry was stirred gently. The beaker was placed in a 95° C. oven, and the steps of Prep Cycle 1 were repeated. As in the case of Prep Cycle 1, the intercalation reaction liquor was recovered, and the adsorbent sample was titrated hot with acetic acid, labeled “Prep Cycle 2,” and saved for cycle testing.

Like the steps of Prep Cycle 2, in a clean PVDF beaker, a third 100 mL portion of Gibbsite-bearing adsorbent precursor was slurried with the recycled intercalation reaction liquor from Prep Cycle 2 to which 5.0 g of LiOH H₂O was added to augment the slurry with both lithium and alkali, and the slurry was stirred gently. The beaker was placed in a 95° C. oven, and the steps of Prep Cycle 2 were repeated. As in the case of Prep Cycles 1 and 2, the intercalation reaction liquor was recovered, and the adsorbent sample was titrated hot with acetic acid, labeled “Prep Cycle 3,” and saved for cycle testing.

The 100 mL sample of “Prep Cycle 4” was prepared using the same steps as Prep Cycle 3, except that the intercalation reaction liquor was augmented with just 4 g of LiOH·H₂O. The four-times-used intercalation reaction liquor was saved for future analysis, and the Prep Cycle 4 adsorbent sample was saved for cycle testing.

Cycle testing results for the four (4) samples (Prep Cycles 1 to 4) demonstrated that the process yields a highly active adsorbent for all four (4) cycles using the augmented recycled intercalation reaction liquor (see Table 3). This process is highly efficient in lithium consumption compared to the base case where 20 g of LiCl and 10 g NaOH would be employed for each intercalation and then discarded.

TABLE 3
Cycle Testing Results Example 1

| Sample | % Li capacity |
|---|---|
| Gibbsite Precursor | 5% |
| Prep Cycle 1 | 100% |
| Prep Cycle 2 | 100% |
| Prep Cycle 3 | 98% |
| Prep Cycle 4 | 95% |

After 270 Intercalation/De-Intercalation Cycles

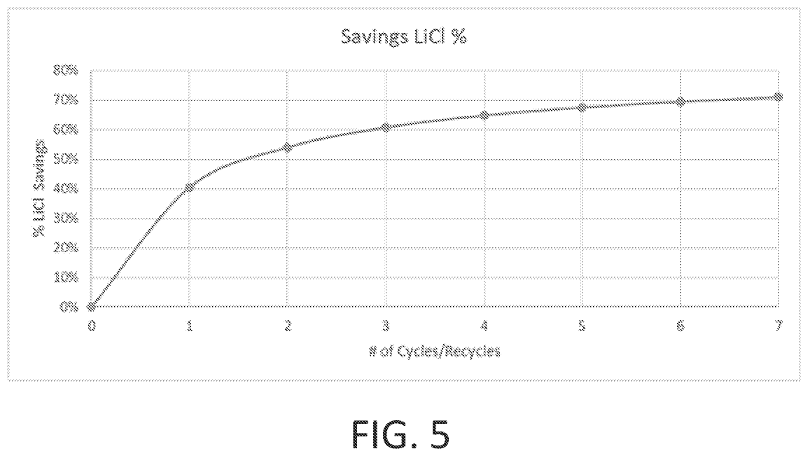

Based on the limited availability of LiCl, commercial production of large quantities of lithium-selective adsorbents can proceed more cost-effectively and efficiently using the process of Example 3. FIG. 5 graphically illustrates the lithium chloride savings with successive recycles. As shown in FIG. 5, by Prep Cycle 2, overall lithium savings reached 50%, and by Prep Cycle 4, lithium savings reached over 63%. In addition, by Prep Cycle 4, LiCl use was reduced by 89% compared to the base case.

### Example 4—Manufacturing a LADH Adsorbent Using a Recycled and LiOH Augmented Intercalation Reaction Liquor in a NaCl Brine

In Example 4, a sample of Gibbsite-form adsorbent precursor was divided into 150 mL portions and intercalated successively by recycling the intercalation reaction liquor. Between each 150 mL intercalation, the intercalation reaction liquor's lithium and alkali content were augmented using LiOH·H₂O like in Example 3, but in Example 4, the reaction media comprised 22% NaCl brine. The use of LiOH·H₂O rather than NaOH assures there is no unwanted build-up of NaCl in the reaction liquor and that the lithium reagents are from a more commercially obtainable source.

For the first activation, Prep Cycle 1, in a PVDF-coated beaker, 150 mL of Gibbsite adsorbent precursor was slurried in 100 mL 22% NaCl brine. Some LiCl was added to Prep Cycle 1 to increase the initial lithium concertation to the desired excess in the intercalation reaction liquor, beyond the level provided by the alkaline LiOH alone. For subsequent Prep Cycles (2-5), the intercalation reaction liquor was augmented by LiOH·H₂O alone. For subsequent cycles, the LiOH·H₂O provided both, the lithium and alkali requirements. Fifteen grams (15 g) of LiCl and 7.5 g of LiOH·H₂O were added to the slurry and stirred until fully mixed. The beaker was placed on a temperature-controlling hotplate apparatus with a mechanical stirrer, loosely covered, and stirred at 95° C. to 98° C. for 3 hr, adding water if needed to maintain the volume. After 3 hr, the beaker was removed from the hotplate apparatus, and the adsorbent slurry was gently mixed and then poured into a 1-inch diameter Pyrex ion exchange column with a sintered PVDF straining disk. The reaction liquor was drained into a separate beaker for use in the next cycle. The flow was stopped when the reaction liquor was level with the top of the resin bed. To the column was added 75 mL (˜½ bed volumes) of 22% NaCl brine, which was slowly drained through the bed, and out to the beaker. This displaced the bulk of the reaction liquor to the beaker and very little remained in the adsorbent sample. The sample was titrated to a lasting pH between 5 and 5.5 at 70° C. to 75° C. using acetic acid and saved for cycle testing. The sample was labeled “Prep Cycle 1”.

In a clean PVDF beaker, a second portion of 150 mL of Gibbsite adsorbent precursor was slurried with the recovered intercalation reaction liquor for Prep Cycle 1, to which 7.5 g of LiOH·H₂O was added and the heating steps of Prep Cycle 1 were repeated. As in the case of Prep Cycle 1, the intercalation reaction liquor was recovered and the adsorbent sample was titrated at 70° ° C. to 75° ° C. to lasting pH between 5.0 and 5.5 using acetic acid, labeled “Prep Cycle 2” and saved for cycle testing.

Prep Cycle 3-5 were carried out in the same way as Prep Cycle 2, each cycle augmented with 7.5 g LiOH·H₂O. As in the case of Prep Cycles 1 and 2, the intercalation reaction liquor was recovered, and the adsorbent sample was titrated hot with acetic acid, labeled “Prep Cycle 3, Prep Cycle 4, and Prep Cycle 5,” and saved for cycle testing.

As shown in Table 4, cycle testing results for the four (4) samples, Prep Cycle 1-5 indicate that this process resulted in highly active adsorbent for all five (5) cycles using the recycled and augmented intercalation reaction liquor. This process is highly efficient in lithium consumption when compared to the base case noted above. By Prep Cycle 5, the overall lithium savings was over 65% in comparison to the base case, taking the lithium demand from 7.5 mol/L down to 2.5 mol/L. There was negligible degradation in adsorbent performance over the five (5) cycles, and no precipitation or crystallization problems were observed, eliminating the need for interstage filtration. Recycling of the intercalation reaction liquor should be possible far beyond the fifth cycle, further eliminating a sizable portion of the lithium from the waste streams (see FIG. 5).

TABLE 4
Cycle Testing Results Example 4

| Sample | % Li capacity |
|---|---|
| Gibbsite Precursor | 5% |
| Prep Cycle 1 | 100% |
| Prep Cycle 2 | 94% |
| Prep Cycle 3 | 103% |
| Prep Cycle 4 | 97% |
| Prep Cycle 5 | 97% |

After 270 Intercalation/De-Intercalation Cycles

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted as a range whose lower limit is 25 and whose upper limit is 100. Additionally, it should be noted that where a range is given, every possible subrange or interval within that range is also specifically intended unless the context indicates the contrary. For example, if the specification indicates a range of 25 to 100, such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only, and decimal and fractional values (e.g., 46.7-91.3) should also be understood to be intended as possible subrange endpoints unless specifically excluded.

It should be understood that the exemplary embodiments described above should be considered in a descriptive sense only and not for purposes of limitation. Descriptions of features or aspects within these embodiments should typically be considered as available for other similar features or aspects in other embodiments.

While one or more embodiments have been described with reference to the figures, it will be understood by those of ordinary skill in the art that various changes in form and details may be made therein without departing from the scope of the inventive concept as defined by the following claims.

What is claimed is:

1. A process for manufacturing a lithium selective adsorbent, the process comprising the steps of:
a. intercalating an initial quantity of an adsorbent precursor with lithium under alkaline conditions at a predetermined intercalation temperature using a pre-intercalation reaction volume of an intercalation reaction liquor to produce an intercalated layered aluminate adsorbent and a post-intercalation reaction volume of a partially depleted intercalation reaction liquor;
b. decanting the post-intercalation reaction volume of the partially depleted intercalation reaction liquor from the intercalated layered aluminate adsorbent to obtain a decanted intercalation reaction liquor;
c. neutralizing the intercalated layered aluminate adsorbent under acidic conditions at a predetermined neutralization temperature to produce the lithium selective adsorbent;
d. augmenting the decanted intercalation reaction liquor by adding a makeup volume to reconstitute the pre-intercalation reaction volume and obtain an augmented intercalation reaction liquor; and
e. recycling the augmented intercalation reaction liquor for intercalating a subsequent quantity of the adsorbent precursor according to step a.

2. The process of claim 1, wherein the intercalation temperature is between about 25° C. and about 125° C.

3. The process of claim 2, wherein the intercalation temperature is between about 85° C. and about 105° C.

4. The process of claim 3, wherein the intercalation temperature is greater than 100° C. to about 105° C.

5. The process of claim 1, wherein the alkaline conditions comprise a pH from about 7 to about 13.

6. The process of claim 5, wherein the pH is between about 9 and about 12.

7. The process of claim 1, wherein the intercalation reaction liquor comprises a lithium salt and an alkali in a dilute brine.

8. The process of claim 7, wherein the lithium salt comprises LiCl, LiNO₃, LiBr, LiOH, or a mixture thereof.

9. The process of claim 8, wherein the lithium salt is LiCl or LiOH.

10. The process of claim 7, wherein the lithium salt in the intercalation reaction liquor has a concentration ratio of about 1:1 to about 5:1 Li to Al.

11. The process of claim 7, wherein the alkali comprises an alkali hydroxide, an alkaline earth metal hydroxide, a strong base, a monoacid base, ammonia, or a mixture thereof.

12. The process of claim 11, wherein the alkali comprises KOH, NaOH, LiOH, or a mixture thereof.

13. The process of claim 7, wherein the alkali has a concentration between about 1 and about 3 mol of the alkali per mol of Al(OH)₃ in the intercalated layered aluminate adsorbent.

14. The process of claim 13, wherein the alkali has a concentration greater than 1 to about 3 mol of the alkali per mol of Al(OH)₃ in the intercalated layered aluminate adsorbent.

15. The process of claim 13, wherein the alkali has a concentration between about 1 and about 1.5 mol of the alkali per mol of Al(OH)₃ in the intercalated layered aluminate adsorbent.

16. The process of claim 15, wherein the alkali has a concentration greater than 1 to about 1.5 mol of the alkali per mol of Al(OH)₃ in the intercalated layered aluminate adsorbent.

17. The process of claim 7, wherein the lithium salt is LiOH, and the alkali is LiOH.

18. The process of claim 7, wherein the brine comprises a majority of chloride salts.

19. The process of claim 7, wherein the brine comprises NaCl, NaBr, NaNO₃, KCl, KBr, or a mixture thereof.

20. The process of claim 7, wherein the brine is NaCl, the lithium salt is LiCl, and the alkali is NaOH.

21. The process of claim 7, wherein the brine is NaCl, the lithium salt is LiOH, and the alkali is LiOH.

22. The process of claim 1, wherein the step a. of intercalating the initial quantity of the adsorbent precursor further comprises intercalating the initial quantity of the adsorbent precursor by heating to the predetermined intercalation temperature for a predetermined amount of intercalation time between about 0.375 hours and about 390 hours.

23. The process of claim 22, wherein the predetermined amount of intercalation time is greater than 100 hours to about 390 hours.

24. The process of claim 23, wherein the predetermined amount of intercalation time is between about 1.5 hours and about 6 hours.

25. The process of claim 1, wherein the neutralization temperature is between about 25° C. and about 115° C.

26. The process of claim 25, wherein the neutralization temperature is between about 65° C. and about 80° C.

27. The process of claim 26, wherein the neutralization temperature is greater than 70° ° C. to about 80° C.

28. The process of claim 1, wherein the acidic conditions comprise a pH from about 4.5 to about 7.

29. The process of claim 28, wherein the pH is between about 5 and about 5.8.

30. The process of claim 29, wherein the pH is greater than 5 to about 5.8.

31. The process of claim 1, wherein the acidic conditions comprise using an acid, and wherein the acid is a strong acid, a mineral acid, a sulfonic acid, a carboxylic acid, or a mixture thereof.

32. The process of claim 31, wherein the acid is hydrochloric acid, sulfuric acid, nitric acid, phosphoric acid, hydrobromic acid, perchloric acid, formic acid, acetic acid, or a mixture thereof.

33. The process of claim 32, wherein the acid is acetic acid.

34. The process of claim 31, wherein the acid has a concentration of between about 5% and about 100%.

35. The process of claim 1, wherein the step of neutralizing the intercalated layered aluminate adsorbent further comprises neutralizing the intercalated layered aluminate adsorbent for a predetermined amount of neutralization time.

36. The process of claim 35, wherein the neutralization time is between about 0.03125 hours and about 16 hours.

37. The process of claim 36, wherein the neutralization time is between about 0.25 hours and about 1 hour.

38. The process of claim 36, wherein the neutralization time is less than 2 hours.

39. The process of claim 1, wherein the makeup volume comprises a makeup brine, a makeup lithium salt, a makeup alkali, or a mixture thereof.

40. The process of claim 39, wherein the makeup brine comprises NaCl, NaBr, NaNO₃, KCl, KBr, or a mixture thereof.

41. The process of claim 39, wherein the makeup lithium salt comprises LiCl, LiNO₃, LiBr, LiOH, or a mixture thereof.

42. The process of claim 39, wherein the makeup alkali comprises KOH, NaOH, LiOH, or a mixture thereof.

43. The process of claim 39, wherein the makeup lithium salt is LiOH, and the makeup alkali is LiOH.

44. The process of claim 39, wherein the makeup brine is NaCl, the makeup lithium salt is LiCl, and the makeup alkali is NaOH.

45. The process of claim 39, wherein the makeup brine is KCl, the makeup lithium salt is LiOH, and the makeup alkali is LiOH.

46. The process of claim 1, wherein the step of recycling the augmented intercalation reaction liquor further comprises the step of filtering the augmented intercalation reaction liquor.

47. The process of claim 1 further comprises successively repeating steps a. through e. until the intercalation reaction liquor is fully depleted or contains excess residual alumina such that the reaction no longer produces the lithium selective adsorbent.

48. The process of claim 47 further comprises successively repeating steps a. through e. between seven times and about three times.

49. The process of claim 48 further comprises successively repeating steps a. through e. up to about three times.

50. The process of claim 1 further comprises the step of producing the adsorbent precursor by forming aluminum hydroxide (Al(OH)₃) crystals in situ within pores of an ion exchange resin.

51. The process of claim 50, wherein the step of producing the adsorbent precursor further comprises the steps of:
impregnating the pores of the ion exchange resin with an aluminum chloride (AlCl₃) solution;
infiltrating the AlCl₃ impregnated resin with an alkali to form Al(OH)₃ microcrystal seeds within the pores of the ion exchange resin;
infiltrating the Al(OH)₃ seeded resin with an alkaline aluminate solution, and
using an acid to remove excess NaOH produced in the Al(OH)₃ microcrystal seeds formation.

52. The process of claim 50, wherein the ion exchange resin is a polystyrene-based ion exchange resin.

53. The process of claim 52, wherein the ion exchange resin is an organic, porous polystyrene-based ion exchange resin bead.

54. The process of claim 53, wherein the ion exchange resin is functionalized as a strong base anion (SBA) or a weakly basic anion (WBA) exchange resin, and optionally wherein the WBA exchange resin is in an HCl form before the step of impregnating the pores of the ion exchange resin with the AlCl₃ solution.

55. A lithium selective adsorbent manufactured by the process of claim 1.

56. A lithium aluminum double hydroxide (LADH) lithium selective adsorbent produced by the process of claim 1.
